(19) United States
(12) Patent Application Publication
(10) Pub. No.: US 2024/0101075 A1
(43) Pub. Date: Mar. 28, 2024

(54) CANTILEVERED READY MIX TRUCK WASH SYSTEM

(71) Applicant: Shumaker Industries, Inc., Northumberland, PA (US)

(72) Inventors: Matthew NYMAN, Northumberland, PA (US); John FACER, Winfield, PA (US); Drew STREIT, Bloomsburg, PA (US); Brett SHUMAKER, Northumberland, PA (US); Nicholas TURNAGE, Millville, PA (US); Elijah YODER, Mifflinburg, PA (US)

(21) Appl. No.: 17/934,370

(22) Filed: Sep. 22, 2022

(51) Int. Cl. B60S 3/04

(52) U.S. Cl. CPC B60S 3/04

(57) ABSTRACT

A ready mix truck wash system including a lower frame adapted for receiving a ready mix truck during operation of the system, an upper frame attached to an upper portion of the lower frame, the upper frame extending beyond an end portion of the lower frame forming a cantilevered structure, and a plurality of nozzles supported at predetermined positions by the lower frame and the upper frame to direct a pressurized liquid for washing the ready mix truck.

### TECHNICAL FIELD

The present invention is directed to systems and methods for washing vehicles, and, in particular, to systems and methods for washing ready mix trucks.

### BACKGROUND

In the concrete business, it is necessary to wash ready mix trucks on a regular basis. After both loading and unloading, trucks should be thoroughly washed in order to remove any material accumulated on the exterior surface. Conventionally, an operator, typically a driver of a ready mix truck, must be provided access, such as a ladder system mounted to ready mix truck or a freestanding support to wash the ready mix truck with a stream of water directed through a hose. There are several disadvantages associated with this approach to wash ready mix trucks, including possible injury to the operator, the time involved to wash ready mix truck, the amount of water expended, and lack of consistency as to the quality of the washing job performed by the operator. Moreover, during the washing process, the amount of water utilized to wash a feed hopper also referred to as a loading hopper or charging hopper may vary widely, similarly adversely affecting the quality of the concrete contained in ready mix truck. This is because an uncontrolled amount of water utilized to wash the inside surface of feed hopper leading to the interior of barrel or drum of ready mix truck is introduced into a barrel or drum and mixes with the load of concrete. “Slump” is a measure of consistency of freshly mixed concrete, as determined by the distance the concrete slumps or spreads outwardly onto a surface after a molded specimen is removed from an inverted funnel-shaped cone. In certain applications, such as road construction, if the slump falls outside of an acceptable range, the load of concrete is rejected, resulting in waste of time and materials. Moreover, a conventional hose utilized to wash ready mix trucks has a flow rate of 1-2 gallons/second, and the addition of as little as 5 gallons of water to a concrete load may be sufficient to result in the load of concrete being rejected (i.e., only 2.5 seconds of water flow directed into the feed hopper).

In order to address shortcomings in the industry, a truck wash system utilizing multiple nozzles that are directed to wash a ready mix truck can be employed. The truck wash system can include an open interconnected frame having a plurality of vertically extending members attached to a ground or connected to bases and a plurality of horizontally extending members, forming a substantially square rigid structure. However, this rigid structure generally takes up a large amount of space at ground level. That is, due to the large footprint of the rigid structure, more space is needed to complete construction or installation of the truck wash system. This results in greater traffic flow in and about the facility.

Further, the multiple nozzles in conventional truck wash systems are typically mounted at predetermined fixed positions, designating that the truck is cleaned only where the predetermined fixed locations are located, resulting in missed coverage and cleaning inefficiencies. That is, as the truck slowly passes through the spray nozzles mounted at predetermined fixed positions, the spray nozzles only sprays water at a specific portion of the vehicle where the spray nozzle can reach. As a result, the objective to uniformly apply water over the entire vehicle to wash the vehicle cannot be achieved.

Another approach has been to utilize moveable structure, such as “arms” to obtain greater coverage for washing the truck. However, in this approach, the moveable structure requires a complex and expensive mechanical system, and is prone to breakdowns requiring regular repairs and maintenance as cementitious environment builds up quickly and prevents movements. Hence, this prevents the arms from moving, which reduces cleaning coverage and effectiveness accordingly.

Therefore, there is a need in the art for a ready mix truck wash systems and methods that efficiently clean the vehicle while maintaining a small footprint at ground level.

### SUMMARY

In an example embodiment, a ready mix truck wash system includes a lower frame adapted for receiving a ready mix truck during operation of the system, an upper frame attached to an upper portion of the lower frame, the upper frame extending beyond an end portion of the lower frame forming a cantilevered structure, and a plurality of nozzles supported at predetermined positions by the lower frame and the upper frame to direct a pressurized liquid for washing the ready mix truck

In another example embodiment, a ready mix truck wash system includes a lower frame adapted for receiving a ready mix truck during operation of the system, an upper frame removably attached to an upper portion of the lower frame, the upper frame includes a horizontally extending member that is positioned beyond an end portion of the lower frame forming a cantilevered structure for supporting the horizontally extending member, and a plurality of nozzles supported at predetermined positions by the lower frame and the upper frame to direct a pressurized liquid for washing the ready mix truck

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of an exemplary ready mix truck wash system, according to an example embodiment.

FIG. 2 is an angled side partial view of the ready mix truck wash system of FIG. 1.

FIG. 3 is a top view of the ready mix truck wash system of FIG. 1.

FIG. 4 is a side view of the ready mix truck wash system of FIG. 1.

FIG. 5 is a perspective view of an exemplary stage of the ready mix truck wash system of FIG. 1.

FIG. 6A is a perspective front view of an exemplary stage of the ready mix truck wash system of FIG. 1.

FIG. 6B is a perspective back view of an exemplary stage of the ready mix truck wash system of FIG. 1.

FIG. 7A is a partial perspective view of an exemplary feed hopper of a ready mix truck with spray nozzles of the ready mix truck wash system.

FIG. 7B is a partial perspective view of an exemplary feed hopper of a ready mix truck with water from spray nozzle entering feed hooper.

FIGS. 8A-8D are partial perspective views of an exemplary stage of the ready mix truck wash system of FIG. 1.

FIG. 9 is a perspective view of an exemplary stage of the ready mix truck wash system of FIG. 1.

FIG. 10 is a perspective view of an exemplary ready mix truck wash system, according to an example embodiment.

FIG. 11A is a perspective view of a holding tank and pump.

FIG. 11B is a view of an exemplary display of the ready mix truck wash system.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

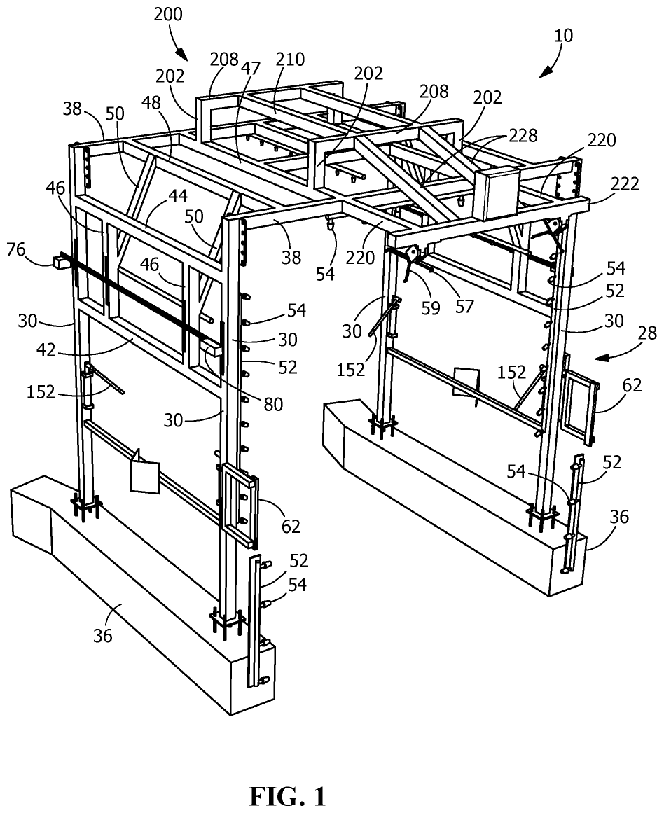

As shown in FIG. 1, an exemplary ready mix truck wash system 10 comprises a lower frame 28 and an upper frame 200 connected to the lower frame 28 near an upper portion of the lower frame 28. In one implementation, the upper frame 200 is removably attached to the lower frame 28. The lower frame 28 is an open interconnected frame resembling an inverted “U” including a plurality of members 30 extending vertically such as tubes having opposed ends 32, 34, with ends 32 connecting to a base platform 36, or alternatively to the ground, and ends 34 connecting to corresponding ends 40 of members 38 extending horizontally. In one implementation, the lower frame 28 includes four vertically extending members 30 and two horizontally extending members 38 forming a substantially box-like rigid structure.

Referring to FIGS. 1-3, other members 42, 44, 46, 47, 48, 50 interconnect to one or more of members 30, 38 and/or to one another to define the lower frame 28. It should be appreciated that members 42, 44, 46, 48, 50 facilitate with structural connectivity and/or strength including reducing stress between the members.

In some implementations, each member 42, 44, 46, 47, 48, 50 can be attached to the respective one or more of members 30, 38 by welding, for example. It should be appreciated that other methods for attachments can be employed, such as, but not limited to, hardware assembly using bolts, screws, and/or rivets, spot welding, brazing, soldering, glue, etc. In other implementations, the members can be integrally formed having a unitary construction. In some implementations, members of the lower frame 28 are made from metal, such as, for example, stainless steel, aluminum, copper, cast iron, etc.

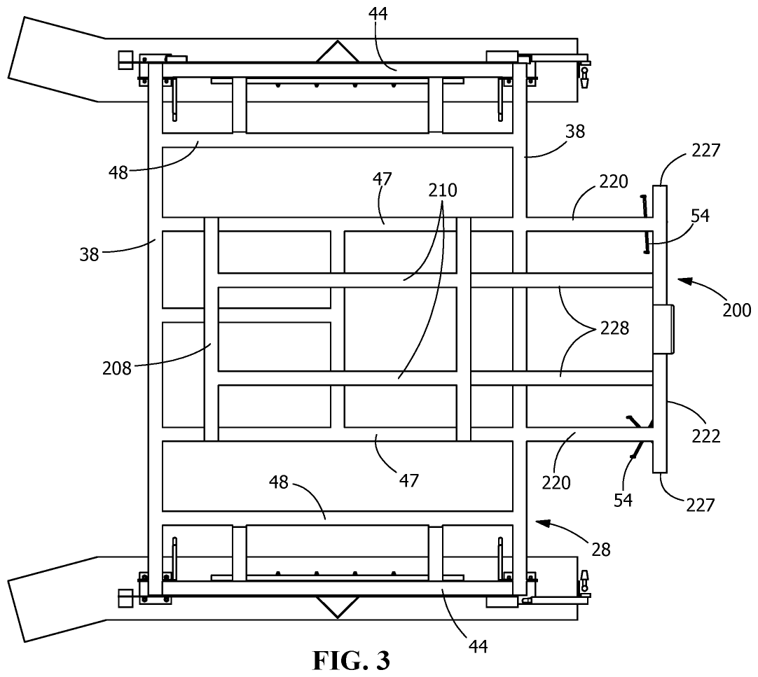

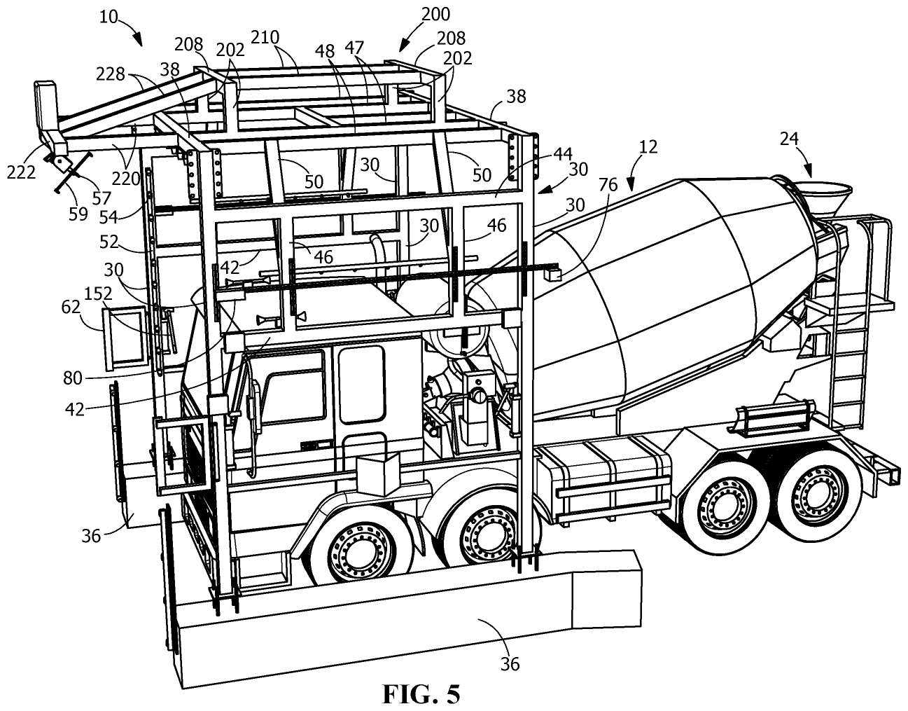

The upper frame 200 is an open interconnected frame including upper members 202 extending vertically having opposed ends 204, 206, with ends 204 connecting to member 47 of the lower frame 28 (FIG. 5), and ends 206 connecting to corresponding ends of upper members 208 extending horizontally. In one implementation, each member 202 can extend vertically, for example, 10 inches in height, creating elevation of the upper frame 28. It should be appreciated that other heights up to 3 feet may be employed to vary the elevation of the upper frame 200. The upper frame 200 includes four upper vertically extending members 202 and two upper horizontally extending members 208, each upper horizontally extending member 208 positioned between a pair of upper vertically extending members 202. To describe in a different manner, the upper horizontally extending members 208 run in a same direction (or parallel) to members 38 of the lower frame 28. Other members 210 (as shown in FIG. 3) interconnect to upper horizontally extending members 208 to define a complete portion of the upper frame 200. As shown in FIG. 3, members 210 run in a same direction (or parallel) to members 48 of the lower frame 28. In some implementations, members 202, 208, 210 of the upper frame 200 are made from metal, such as, for example, stainless steel, aluminum, copper, cast iron, etc.

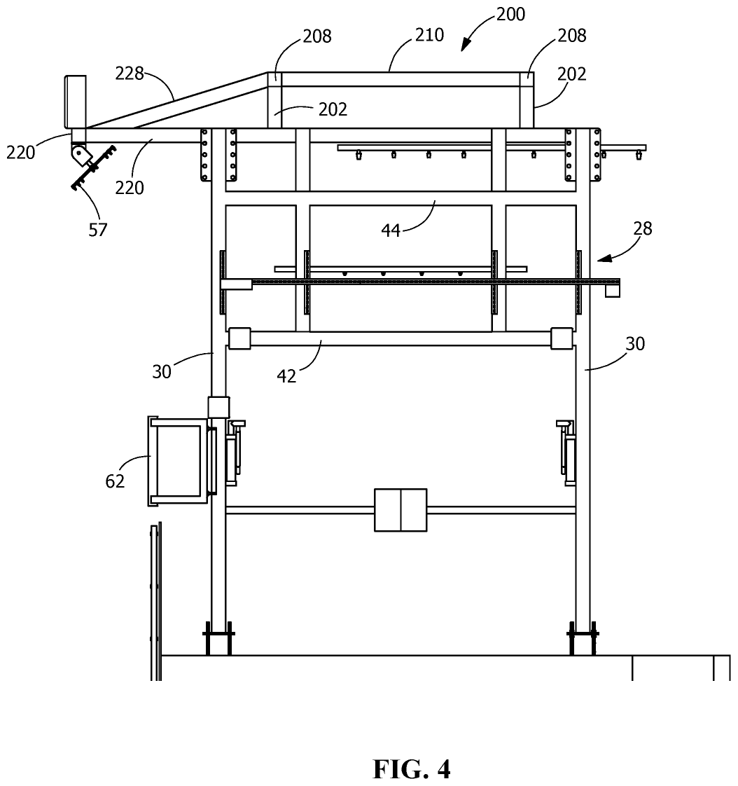

Referring further to FIG. 3, extending from members 47 are extending members 220 interconnected to a horizontally extending member 222 which is positioned beyond an end portion of the lower frame 28. In other words, the horizontally extending member 222 is disposed farther away from member 38 in a direction of the ready mix truck 12 travel. To describe in a different manner, the horizontally extending member 222 is perpendicularly positioned with respect to a travel direction of the ready mix truck 12. The horizontally extending member 222 includes mounted spray equipment farther away from the lower frame 28, which will be described later. Similarly, extending from members 210 are extending members 228 interconnected to the horizontally extending member 222. Because members 208 (supported by the upper vertically extending members 202) of the upper frame 200 are at a higher elevation with respect to the horizontally extending member 222, extending members 228 are angled as seen from a side view of the system 10 (FIGS. 1 and 4). That is, extending members 228 are positioned in an angle a in relation to extending members 220, both extending members 220, 228 being attached perpendicularly to the horizontally extending member 222. In some implementations, the angled extending members 228 are between approximately 10-25 degrees, dependent upon a height of the vertically extending member 202. This configuration of the upper frame 200 including extending members 220, 228 provides a cantilever structure for supporting the horizontally extending member 222. As shown in FIG. 3, the cantilevered extending members 220, 228 extend from and are supported at members 38, 208, respectively. Due to the cantilevered design, the upper frame 200 creates greater cleaning surfaces and effectiveness, all while maintaining a small footprint at the ground level, as compared to conventional wash systems. In one example embodiment, the system 10, i.e., the lower frame 28, can have a footprint of 110 in (9.2 ft) by 156.5 in (13.1 ft) for an area of 17,215 sq in (119.6 sq. ft) and the cantilever can be 194.2 in (16.2 ft) by 156.5 in (13.1 ft) for an area of 30,392.3 sq. in (211.1 sq. ft). To describe in different manner, the cantilevered design can create greater volume area as an overhead structure while maintaining the small footprint of the lower frame 28. As such, footprint design constraint is evaded as the cantilevered design permits assembling or building the system 10 in a tight space. Moreover, the cantilevered design creates additional overhead structure to support additional equipment and machinery while maintaining the same footprint of the lower frame 28. That is, greater volume area is achieved by the overhead structure on an existing system.

In addition, the cantilever design maintains structural rigidity by connecting the framework to the ground via legs. These legs allow the overhead structure to be larger than the footprint at ground-level. Since the overhead structure is taller than the vehicles being washed, the system allows for cross-traffic and easier cleaning.

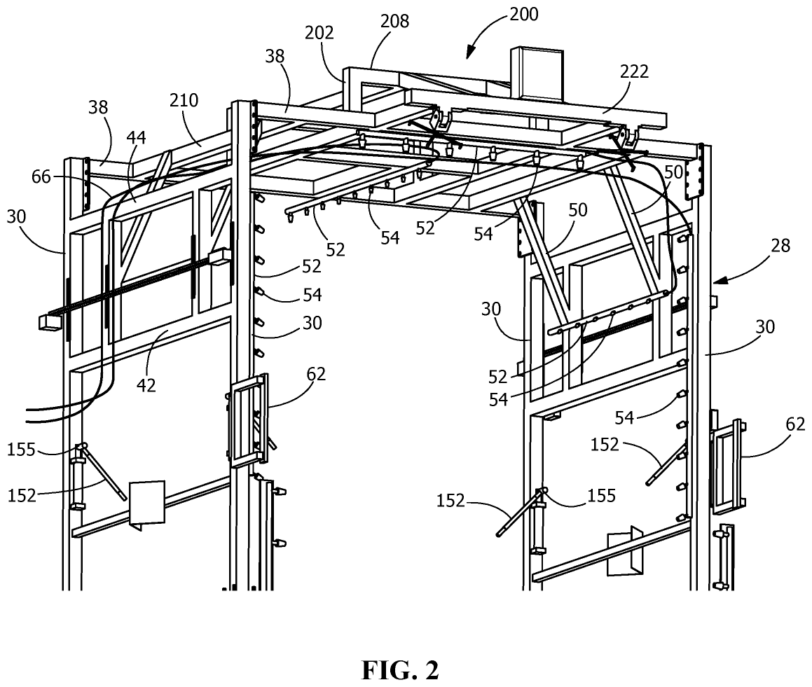

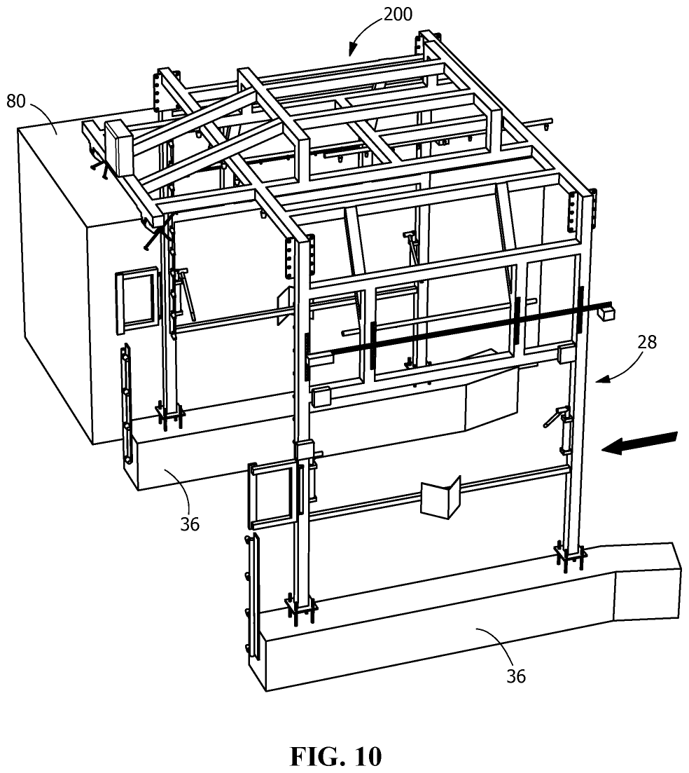

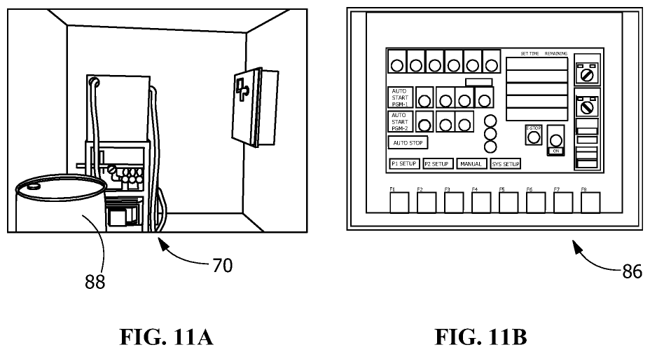

A plurality of nozzles 54 are positioned at predetermined locations of tubes 52 that generally extend along and are supported on members 30, 38, 44, 46, 48, 50 of the lower frame 28 and direct a pressurized liquid, such as water drawn from a holding tank 88 via a pump 70 (FIG. 11A) contained in a container housing 80 (FIG. 10) for washing a ready mix truck 12. The liquid is delivered to the nozzles 54 via a rubber hose line 66 (shown in FIG. 2). In one embodiment, one or more tubes 52 may be flexible made from, for example, but not limited to, plastic. In some implementations, at least a portion of the liquid may be conveyed directly through nozzles 54 positioned at predetermined locations of one or more of members 30, 38, 42, 44, 46, 48, 50. In some implementations, tubes 52 may also be at an angle away from one or more of members 30, 38, 44, 46, 48, 50, such as, for example, away from member 48 positioned approximately mid span at the top of frame 28. As shown in FIG. 2, clusters of nozzles 54 may be positioned that are mutually perpendicular or parallel to a travel direction of the ready mix truck 12 relative to frame 28. For example, cluster of nozzles 54 on member 30 spray liquid perpendicularly to the travel direction and cluster of nozzles 54 on member 46 spray liquid parallel to the travel direction. It should be understood that other arrangements/configurations may be employed besides the one mentioned above. Moreover, these clusters of nozzles 54 generally define spray arches of pressurized liquid applied to the outside surface of the ready mix truck 12 (FIG. 5) for washing and/or cleaning. In one implementation, there may be over 100 nozzles 54 each spraying 1000 psi of water, for example. It should be appreciated that more or less nozzles including other water pressures may be implemented.

In some implementations, in addition to the nozzles 54 being positioned in the lower frame 28, nozzles 54 can be positioned in the upper frame 200. By way of example, nozzles 54 can be positioned on member 208 and/or member 210 in the upper frame 200. In other implementations, nozzles 54 can be positioned in the cantilevered structure, such as, member 220 and/or member 228.

Referring back to FIG. 1, the horizontally extending member 222 includes nozzles 57 in order to spray liquid in a further direction of travel. That is, because nozzles 57 are positioned farther away from the structure of the lower frame 28, larger coverage of spray wash at greater angles is achieved. In one implementation, each nozzle 57 can be attached on a rotating extension member 59 acting as a rotary nozzle to rotate the liquid in a circular motion. In some implementations, the rotary nozzles can be located near each end 227 of the horizontally extending member 222 (as best shown in FIG. 3).

In other implementations, nozzles 54 on member 38 (positioned directly above to direct water in perpendicular direction) are attached on a rotating extension member 59 (FIG. 2) to rotate the water in a circular motion.

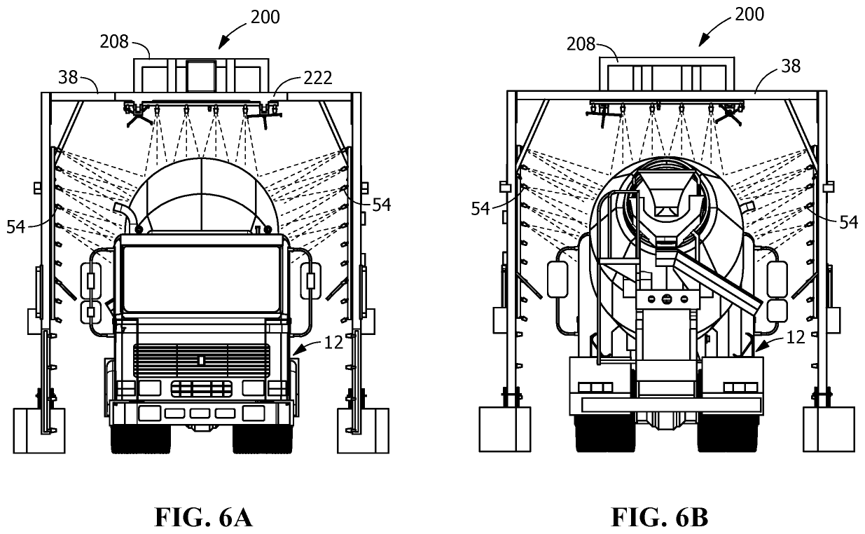

FIGS. 6A-6B, 8A-8D, and 9 show stages of operation of the ready mix truck wash system 10. In some implementations, the lower frame 28 includes an indicator 62 similar to a conventional traffic light containing green, yellow and red lights, for directing a driver or operator through the ready mix truck wash system 10. For example, when the green light is displayed, the ready mix truck wash system 10 is ready for use. In response to the ready mix truck 12 moving sufficiently in travel direction such that the ready mix truck 12 is in sufficient proximity so as to be detected such as by breaking (e.g., breaking the sight line of) respective beams of sensors 76, sometimes referred to as proximity sensors or “electric eyes,” as shown in FIG. 1, the yellow light of indicator is illuminated, and a controller 86 (FIG. 11B) activates a pump 70 for a first stage spray of pressurized liquid applied through nozzles 54 to the outside surface of the ready mix truck 12.

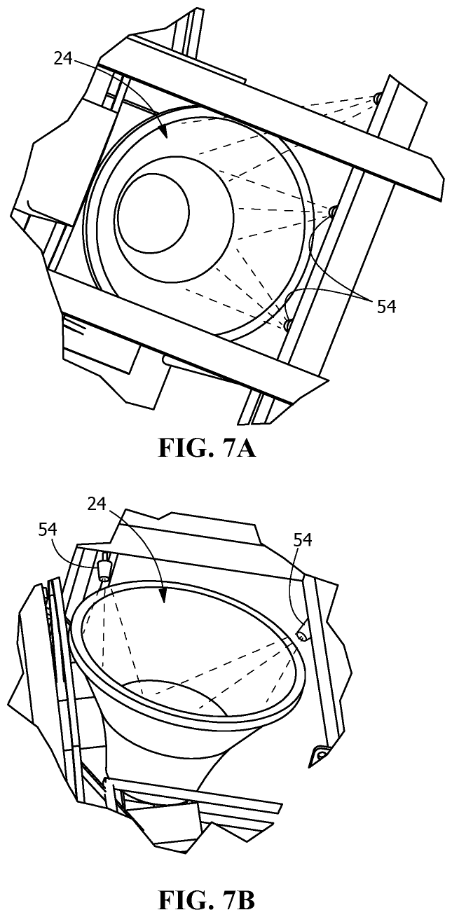

In the first stage spray, which may be applied coincident with nozzles 54 in the lower frame 28 located on member 30 and in conjunction with (rotary) nozzles 54 on member 38 direct water into a hopper 24 of the ready mix truck 12, intended to wash the hopper 24 and add water into the mix (as shown in FIGS. 7A and 7B). In one implementation, 7 gallons per minute of water is added to the mix. Congruently, nozzles 57 on member 222 can also operate to spray water toward the hopper 24 of the ready mix truck 12. Next, in a second stage stray, the ready mix truck wash system 10 activates the pump 70 for nozzles 54 to wash other portions of the outer surface of the ready mix truck 12, such as the cab, the windshield and/or the mixer drum 26.

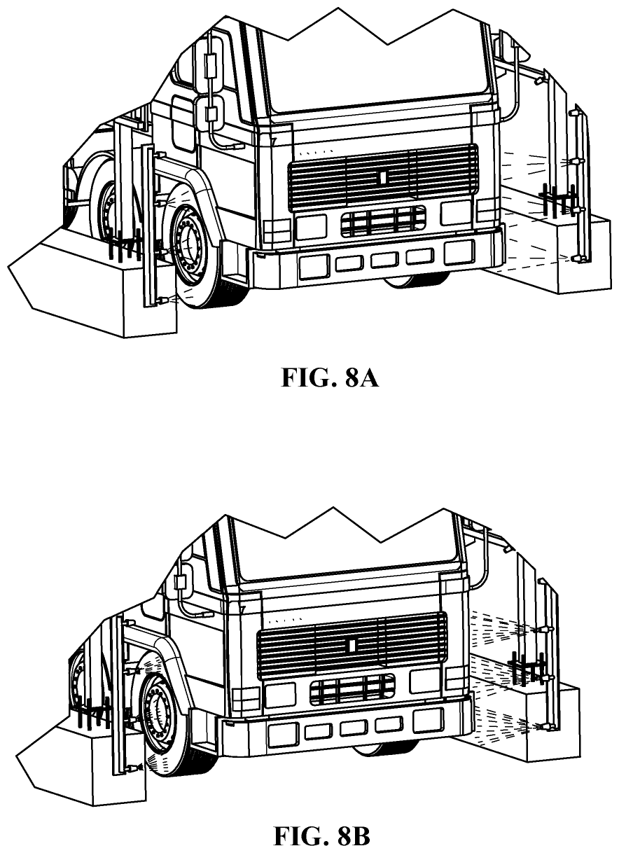

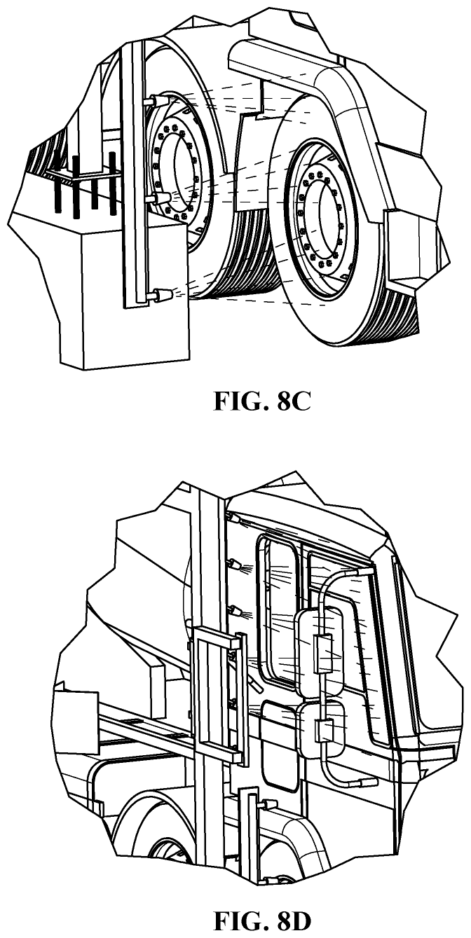

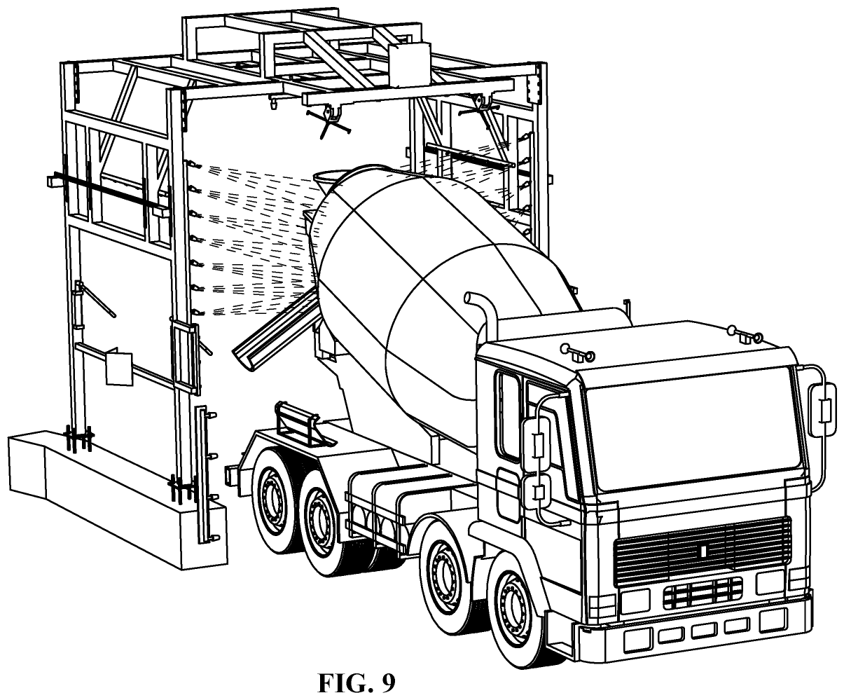

After a predetermined time, the ready mix truck wash system 10 displays a green light to commence movement of the ready mix truck 12 in a third stage spray. In response to additional movement of the ready mix truck 12 in travel direction such that the ready mix truck 12 is to be detected, such as, by sensors 80, sometimes referred to as proximity sensors or “electric eyes,” or a laser, the controller 86 activates the pump 70 to spray water through nozzles 54 (on member 30) to provide a dedicated wash for the wheels, the mirrors and windows of the ready mix truck 12 (FIGS. 8A-8D). Lastly, in a fourth stage spray, the ready mix truck wash system 10 activates the nozzles 54 to wash mid-to-back portions of the ready mix truck 12 while moving in the travel direction (FIG. 9).

It is to be understood that the controller controls operation of the sensors, the pump, the indicator and/or other components of the system in a known manner that is not further discussed herein.

It is to be understood that the sensors are adapted to detect conditions such as the ready mix truck being out of position in a manner that could lead to a collision or inadvertent contact or damage the system, including the possibility that a differently configured ready mix truck, for example, having dimensions too large to be accommodated by the frame of the system (vertically or laterally), such as inadvertently not removing an attachment protruding from the ready mix truck or failing to return a component to its retracted position, such as the hopper, leading to the possibility of shut-down of operation of the system, preceded by appropriate indications by the indicator, which may include, for example, flashing lights and/or audio alarm, to the driver of the ready mix truck in an effort to avoid damage to the system or the ready mix truck.

For purposes herein, the terms “sensors,” or “proximity sensors” or “electric eyes” are intended to refer to non-contact devices capable of detecting, within a predetermined distance range, the presence of an object “activated condition” (i.e., the object breaking/reflecting the emitted sensor beam) or the non-presence “deactivated condition” (i.e., absence of the object breaking/reflecting the emitted sensor beam). Examples of such “sensors” may include capacitive, eddy-current, inductive, magnetic, including magnetic proximity fuse, optical photoelectric, photocell (reflective), laser, passive (such as charge-coupled devices), passive thermal infrared, radar, reflection of ionizing radiation, sonar (typically active or passive), ultrasonic, fiber optics, and Hall effect.

It is further noted that the sensors are activated only within a predetermined range, meaning that only if an object is positioned outside that predetermined range, e.g., fails to break the respective beams, the sensors remain deactivated. Sensors are controlled by controller in a known manner such that when sensor is activated as a result of beam being interrupted or sensor being uninterrupted (i.e., an uninterrupted beam as a result of not being interrupted), the red light of indicator is illuminated, indicating that ready mix truck 12 is not properly positioned under/over a cluster of nozzles. In response to red light of indicator being illuminated, the driver of the ready mix truck 12 applies the brakes to the ready mix truck 12. In case of over-travel of ready mix truck 12 relative to cluster of nozzles 54, (e.g., sensors 76, 80 sufficiently to change the respective interrupted/uninterrupted status), the red light of indicator is caused to “blink,” requiring the driver to reverse travel direction, the driver again applying the brakes to stop ready mix truck 12, at least temporarily, when the red light is “solid,” i.e., no longer blinking.

Further, in response to the ready mix truck 12 remaining in position for a predetermined time period such as three seconds, the controller 86 opens a solenoid valve (not shown) to permit the pump 70 to direct pressurized water to flow through cluster of nozzles 54, defining the first stage spray. In one embodiment, the pump 70 remains on during the operation of the truck wash system. Substantially all of the pressurized water of the first stage spray is directed onto inside surface of feed hopper 24 and flows into barrel 26 or drum of ready mix truck 12, thereby mixing with the concrete load. The controller 86 closes the solenoid valve (not shown) to pump after operating for a predetermined time period such as 10 seconds, thereby shutting off flow of the first stage spray. As a result of nozzles 54 having orifice sizes restricting water flow at a predetermined water pressure, the pump 70 delivers the pressurized water through the nozzles 54 of the first stage spray at a known flow rate, such as 45 gallons/minute and operating for a tightly controlled predetermined time, such as 10 seconds, the amount of water introduced into the concrete load, 7 gallons in this case, may be very closely controlled, e.g., 0.5 gallons, or less of deviation. Therefore, by withholding the desired amount of liquid (e.g., 7 gallons) in the concrete load initially loaded into the ready mix truck 12, the desired amount of liquid is contained in the concrete load after washing the ready mix truck.

Once the flow of pressurized water from the first stage spray is shut off, pressurized water from nozzles 54 forming the second stage spray is initiated. The second stage spray is applied to the outer surface of ready mix truck 12, primarily to the outer surface of the barrel or drum 26. At this time, the driver resumes travel of ready mix truck 12 in travel direction away from ready mix truck wash system 10. Upon beams of sensors 80 (FIG. 1) no longer being broken by ready mix truck 12, controller 86 deactivates the pump 70 after a predetermined time period.

In some implementations, in order to generally center the ready mix truck 12 moving parallel to the travel direction during operation of ready mix truck wash system 10, optional opposed guides (not shown) extend generally parallel to the travel direction, with converging guide portions to help initially guide ready mix truck 12 under the frame 28. The opposed guides can be near or adjacent to the base platform 36 for protecting the ready mix truck 12 from hitting the frame 28.

In some implementations, as shown in FIG. 2, extension members 152 extend inwardly from the lower frame 28, such as from members 30 may include a spring 154 that permits the extension member 152 to resiliently deflect away from an extended position as a result of rubbing against a portion of the ready mix truck 12, such as a side mirror when the ready mix truck 12 is not sufficiently centered in the lower frame 28. In response, the driver can reverse direction and properly realign (i.e., “center”) the ready mix truck 12 relative to the lower frame 28 without damaging either the lower frame 28 or the ready mix truck 12.

For purposes herein, the term “ready mix truck” and the like is meant generally and includes any vehicle used in the construction concrete industries.

It is to be understood that the ready mix truck wash system of the present invention may be adapted for use with numerous ready mix truck designs, such as front or rear loading.

As described herein, the term “proximal” end relates to an end being closest to the ground, and the term “distal” end relates to an end being farthest from the ground.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A ready mix truck wash system, comprising:
a lower frame adapted for receiving a ready mix truck during operation of the system;
an upper frame attached to an upper portion of the lower frame, the upper frame extending beyond an end portion of the lower frame forming a cantilevered structure; and
a plurality of nozzles supported at predetermined positions by the lower frame and the upper frame to direct a pressurized liquid for washing the ready mix truck.

2. The ready mix truck wash system of claim 1, wherein the upper frame includes a horizontally extending member that is perpendicularly positioned with respect to a travel direction of the ready mix truck.

3. The ready mix truck wash system of claim 2, wherein the horizontally extending member is supported by a first extending member that is supported by a portion of the lower frame and a second extending member that is supported by a portion of the upper frame.

4. The ready mix truck wash system of claim 3, wherein the second extending member is angled with respect to the first extending member.

5. The ready mix truck wash system of claim 1, wherein the plurality of nozzles is attached to an extension member that rotates for directing the pressurized liquid in a circular motion.

6. The ready mix truck wash system of claim 2, wherein the horizontally extending member includes a plurality of nozzles that rotates on a rotating extension member.

7. The ready mix truck wash system of claim 1, wherein the lower frame is an inverted “U”.

8. The ready mix truck wash system of claim 1, wherein the upper frame is removably attached to the lower frame.

9. The ready mix truck wash system of claim 1, wherein the plurality of nozzles is arranged in a plurality of clusters, each cluster of the plurality of clusters is positioned in a plane.

10. The ready mix truck wash system of claim 9, wherein each plane is perpendicular to a travel direction of the ready mix truck during operation of the system.

11. The ready mix truck wash system of claim 9, wherein each cluster of the plurality of clusters defines a spray arch for washing the ready mix truck.

12. The ready mix truck wash system of claim 1, further comprising:
a controller; and
a plurality of sensors controlled by the controller for monitoring a position of the ready mix truck relative to the lower frame, the upper frame, and the plurality of nozzles in preparation of operation and during operation of the system.

13. The ready mix truck wash system of claim 12, wherein the controller is configured such that, in response to the ready mix truck being temporarily positioned at a first fixed position during operation of the system, a controlled predetermined volume of pressurized liquid is introduced into a barrel of the ready mix truck from at least one nozzle of the plurality of nozzles.

14. The ready mix truck system of claim 12, wherein the plurality of sensors are adapted to position the ready mix truck at a first fixed position;
wherein with the ready mix truck at the first fixed position, a portion of nozzles of the plurality of nozzles are positioned in proximity of a feed hopper of the ready mix truck in preparation of directing pressurized liquid into the barrel of the ready mix truck.

15. The ready mix truck wash system of claim 12, wherein the plurality of sensors comprises eddy-current, inductive, magnetic, including magnetic proximity fuse, optical photoelectric, photocell (reflective), laser, passive (charge-coupled devices), passive thermal infrared, radar, reflection of ionizing radiation, sonar (active or passive), ultrasonic, fiber optics, and Hall effect sensors.

16. The ready mix truck wash system of claim 1, wherein the controlled predetermined volume of pressurized liquid is 7 gallons plus/minus 0.5 gallons or less.

17. A ready mix truck wash system, comprising:
a lower frame adapted for receiving a ready mix truck during operation of the system;
an upper frame removably attached to an upper portion of the lower frame, the upper frame includes a horizontally extending member that is positioned beyond an end portion of the lower frame forming a cantilevered structure for supporting the horizontally extending member; and
a plurality of nozzles supported at predetermined positions by the lower frame and the upper frame to direct a pressurized liquid for washing the ready mix truck.

18. The ready mix truck wash system of claim 17, wherein the horizontally extending member is supported by a first extending member that is supported by a portion of the lower frame and a second extending member that is supported by a portion of the upper frame.

19. The ready mix truck wash system of claim 18, wherein the second extending member is angled with respect to the first extending member.

20. The ready mix truck wash system of claim 17, wherein the upper frame includes vertically extending members to elevate a height of the upper frame.
